(19) United States
(12) Patent Application Publication
(10) Pub. No.: US 2023/0030955 A1
(43) Pub. Date: Feb. 2, 2023

(54) RECORDING, SHARING, AND TRADING INDUSTRIAL PROCESS-RELATED INFORMATION VIA DISTRIBUTED LEDGERS

(71) Applicant: Kurt Peter Gilson, Tucson, AZ (US)

(72) Inventor: Kurt Peter Gilson, Tucson, AZ (US)

(21) Appl. No.: 17/835,669

(22) Filed: Jun. 8, 2022

Related U.S. Application Data
(60) Provisional application No. 63/208,357, filed on Jun. 8, 2021.

(51) Int. Cl. G05B 19/4155

(52) U.S. Cl. CPC G05B 19/4155; G05B 2219/31449

(57) ABSTRACT

The present invention extends to methods, systems, and computer program products for recording, sharing, and trading industrial process-related information via distributed ledgers. A program defines an industrial process to be performed at an industrial machine. The industrial machine is activated performing the industrial process in accordance with the program. Industrial process data is collected during and corresponding to performance of the industrial process. The industrial process data is stored to a distributed ledger as a component of a smart contract associated with performing the industrial process. It is determined that the industrial data was stored to the distributed ledger in a timely and accurate fashion. An amount of token is added to an account of a machine operator in response to determining that the process data was stored to the distributed ledger in a timely and accurate fashion.

### CROSS-REFERENCE TO RELATED APPLICATIONS

This application claims the benefit of U.S. Provisional Patent Application Ser. No. 63/208,357, entitled “RECORDING, SHARING, AND TRADING PROCESS-RELATED INFORMATION VIA DISTRIBUTED LEDGERS”, filed Jun. 8, 2022, which is incorporated herein in its entirety.

### BACKGROUND

### 1. Background and Relevant Art

Modern industrial manufacturing is based on increasingly complex and highly engineering process systems designed to ensure product quality at high yields while meeting strict safety and environmental standards. One of the ways manufacturers are able to meet these requirements is by the extensive use of welded metal and plastic components in their process systems.

Adding to this challenge is that in order to meet strict safety and regulatory standards, the materials of construction and workmanship have to be documented extensively. Each weld needs to be verified, recorded and made part of a permanent facility record. Despite attempts to digitize this process for other highly documented and regulated industries such as nuclear and pharmaceutical, the quality control documentation systems are most often paper-based or scanned records tracked with spreadsheets or proprietary relational databases.

### BRIEF SUMMARY

Examples extend to methods, systems, and computer program products for recording, sharing, and trading industrial process-related information via distributed ledgers. A program defines an industrial process to be performed at an industrial machine. The industrial machine is activated performing the industrial process in accordance with the program. Industrial process data is collected during and corresponding to performance of the industrial process. The industrial process data is stored to a distributed ledger as a component of a smart contract associated with performing the industrial process. It is determined that the industrial data was stored to the distributed ledger in a timely and accurate fashion. An amount of token is added to an account of a machine operator in response to determining that the process data was stored to the distributed ledger in a timely and accurate fashion.

In a more specific aspect, a program defines a weld to be performed at a welding machine. The welding machine is activated performing the weld in accordance with the program. Weld data is collected during and corresponding to performance of the weld. The weld data is stored to a distributed ledger as a component of a smart contract associated with performing the weld. It is determined that the weld data was stored to the distributed ledger in a timely and accurate fashion. An amount of token is added to an account of a welder in response to determining that the weld data was stored to the distributed ledger in a timely and accurate fashion.

In general, the amount of token rewards can be based upon the relative value of the certification held by the machine operator, such as, the welder.

### BRIEF DESCRIPTION OF THE DRAWINGS

In order to describe the manner in which the above-recited and other advantages and features can be obtained, a more particular description will be rendered by reference to specific implementations thereof which are illustrated in the appended drawings. Understanding that these drawings depict only some implementations and are not therefore to be considered to be limiting of its scope, implementations will be described and explained with additional specificity and detail through the use of the accompanying drawings in which:

FIG. 1 depicts an example distributed ledger architecture.

FIG. 2 depicts an example process flow for utilizing weld information in a distributed ledger architecture.

FIG. 3 depicts an example map of level asset functions.

FIG. 4 depicts another example map of asset and smart contract functions.

FIG. 5A depicts a user interface screen for registering a weld.

FIG. 5B depicts a user interface screen for recording a weld.

FIG. 5C depicts a user interface screen for a weld inspection.

FIG. 5D depicts a user interface screen for requesting a weld log for a welder.

FIG. 5E depicts a user interface screen for site set up.

FIG. 5F depicts a user interface screen for engineer set up.

FIG. 5G depicts a user interface screen for a procedure set up.

FIG. 5H depicts a user interface screen for a welder set up.

FIG. 5I depicts a user interface screen for an inspector set up.

FIG. 6 depicts an example of a user wallet screen.

### DETAILED DESCRIPTION

Examples extend to methods, systems, apparatus, and computer program products for recording, sharing, and trading industrial process-related information via distributed ledgers.

Integrating component manufacturers, distributors, engineers, contractors, third party quality inspectors, plant owners and end-users across complex supply chains is highly inefficient. Efficiencies can be gained using distributed ledger technology (DLT).

More particularly, industrial welding is a large market. In North America alone, roughly 4,000 welds are made each hour, or over 35,000,000 per year. The documentation and inspection costs for these welds is around 2.0B per year. Documentation and inspection of other industrial processes can also be costly. Recent studies have indicated that even rudimentary digital sharing of welding data can reduce documentation costs by 60%. By incorporating a blockchain solution using Internet of Things (IoT) sensors and existing last mile solutions, the cost of industrial process verification can be dropped even further, representing significant savings across the network.

Particular to welding, in order for a weld to be accepted into a manufacturing process system, the weld is to have the following proofs associated with it:

Proof that the welding procedure was verified by an accredited third party

Proof that the welder was certified on the welding procedure

Proof that the machine used to make the weld was calibrated

Proof that the program used to make the weld was certified

Proof that inside and outside of the weld was purged during welding

Proof that the purge gas was of acceptable purity

Proof that the metals that were welded met metallurgical requirements (via heat certification)

Proof that the welding machine that made the weld completed the program with no faults or error codes

Proof via a weld map that the documentation is associated with the correct weld

Proof that the weld was inspected and accepted by an accredited third party inspector

Proof that the inspector had the required certification.

Each of these proofs can start out as a paper document which is sent via mail (or FedEx) or scanned and emailed to the next party in the chain for further collation, eventually into a paper or .pdf binder. Best case, these documents end up in a customer data warehouse where then can be more readily accessed for system validation and acceptance. The reconciliation process associated with these proofs is performed manually by quality auditors who verify the proper documentation before releasing final funds for payment. DSO of 60 to 90 days is typical for the players in this supply chain.

Other industrial processes can include similar proof requirements also resulting in digital paper trails and manual audits.

A distributed ledger can be used to decrease the cost of verification of these transactions by having each proof be a block in a weld (or other industrial process) documentation chain that can be checked against databases maintained by trusted manufacturers and inspection agencies. For example, the component and consumable manufacturers would maintain on-line records of lot certifications produced to industry standards. Inspection agencies can maintain on-line records of approved weld (or other industrial process) procedures and welders (or other industrial workers) certified to those procedures. The welders (or other industrial workers) can obtain a digital identity, as would each of the certified welding (or other industrial) machines. As parts of an industrial process are completed, the parts can each be verified against the trusted agency database, linked to the digital identity and added to the blockchain linked to the weld's (or other industrial process's) digital identity.

Aspects of the invention can be anchored on blockchain technology that can permanently record transaction related to the production and certification of industrial welds (or other industrial processes) and to account for token payments and rewards. Smart contracts on blockchain are used to validate the credentials of data contributors, such as, welders, welded parts, etc., and to transfer tokens between blockchain addresses.

Aspects of the invention can use the W3C Verifiable Credential standard. The W3C standard specifies the data model to be used for decentralized identifiers (DIDs), credential schemas, machine-readable verifiable credentials (VCs), VC presentations and digital signatures. The W3C standard further establishes an architecture of issuers, subjects, holders and verifiers of credentials that is well suited for use with distributed ledgers and can leverage other VD platforms or open Software Development Kits (SDKs). VC verification (authentication) can be handled “off-chain”. On the other hand, validation of required claims can be handled “on-chain”.

A distributed ledger ecosystem can be based on a pay-per-weld model (or pay per industrial process) to incentivize contribution of verifiable welding (or industrial process) data. The distributed ledger ecosystem can utilize user identity and certification management, token management, data entry validation, blockchain search, and reporting.

A data exchange platform can receive payments from customers for tokens usable to unlock data elements related to industrial processes, such as, certified welding. Customers can enter into a data agreement with the data exchange platform per site that specifies available data elements and cost per each data element. For example, a certified weld may include around 20 data elements. For each of the around 20 data elements, the data exchange platform can be used to define a per data element cost in token. Different data elements may cost more or less that other data elements or some data elements may cost the same. For example, weld material used for a weld may cost less than a welder identifier of the welder but more than the size of the weld. Per data element pricing gives the data exchange platform as well as customers more granular control over data access. Per data element pricing can be similarly used for data associated with other industrial processes.

Aspects of the invention include reducing resource consumption and cost of weld (or other industrial process) verification using distributed ledger technology tied to last mile solutions while bootstrapping network effects using a (e.g., WELDcoin) token. A (e.g., WELDChain) network can transform otherwise fragmented welding (or other industrial process) supply chain activates into an ecosystem where participants can share information and create new business opportunities in an environment where individuals and organizations have control over their information and trust the information in a distributed ledger (e.g., blockchain)

Use of a distributed ledger (e.g., blockchain) can liberate welders (as well as other industrial process workers) from organizations that currently hold information on the product of their labor. Welders (and other industrial process workers) are often paid by the hour at wages set by unions or local non-union labor markets. However, the value of the welds (or other industrial processes) that they produce (or implement) is largely captured by contractors or other intermediaries. Most welders (and other industrial workers) are constantly on the move from one company to another and their certifications and weld (or other process) history are lost when they move. A distributed ledger ecosystem gives them control over their welding (or other industrial process) history, and for the best and most productive welders (and other industrial process workers), allows them to earn a higher wage. Most welders (and other industrial process workers) take great pride in their work and are open to sharing their verified weld (and other industrial process) histories with facility owners or contractors. They are also fiercely independent and want to know that they have control over who can access the information.

Within a distributed ledger ecosystem, new business opportunities can arise using distributed ledger-based wielding (and other industrial process) information, including:

Job postings where owners and contractors can advertise welding (or other industrial process) opportunities and AI can match the most qualified welders (or other industrial process workers) with the best certifications, weld (or industrial process) history and location and welders (as well as other industrial process workers) can control their information and let their services to the highest bidder;

Real-time and verifiable productivity and progress tracking on projects;

Welding (and/or other industrial process) analytics based on aggregation of industry data;

Targeted advertising with user approvals;

Quality reporting services to assist with contractor pre-qualification;

Contractor and Welder (or other industrial process) Leaderboards based on weld (or other industrial process) production and weld (or other industrial process) rejection rates.

These enhancements to a distributed ledger ecosystem can further bind participants to the ecosystem and encourage ecosystem expansion.

In additional to welding, a distributed ledger ecosystem can also be used across other industrial processes and other processes in general, including but not limited to: construction workflow, project and supply chain management, project financial integration, IoT smart contracts, modular residential construction, building lifecycle management, construction quality applications including structural, electrical, medical gas, security, life safety, etc.

In one aspect, a distributed ledger ecosystem is owned and managed by a foundation composed of a plurality of (and potentially all) stakeholders (as opposed to a private venture that may meet resistance form institutions reluctant to trust a single provider). In addition to marketing to owners, a distributed ledger ecosystem can incentivize individual welders, other process workers, inspectors and contractors to start adding information onto the distributed ledger and earn token (e.g., WELDcoins) even before owners utilize the platform on their sites. The amount of token that the contributors earn can increase as the owners drive implementation, giving the individual contributors a reason to bring owners into the distributed ledger ecosystem.

A distributed ledger ecosystem can also allow contractors and owners to use their existing methods for identifying welds, welders, other industrial processes, other industrial workers, inspectors, procedures, etc. An industry-wide data standard is not required for a distributed ledger ecosystem. The distributed ledger ecosystem can be used to manage information associated with a welding or other processes. However, the distributed ledger ecosystem is not necessarily used for financial transactions associated with making the welds or other industrial processes. As such, commercial and financial transactions need not be modified, simplifying adoption of the distributed ledger ecosystem.

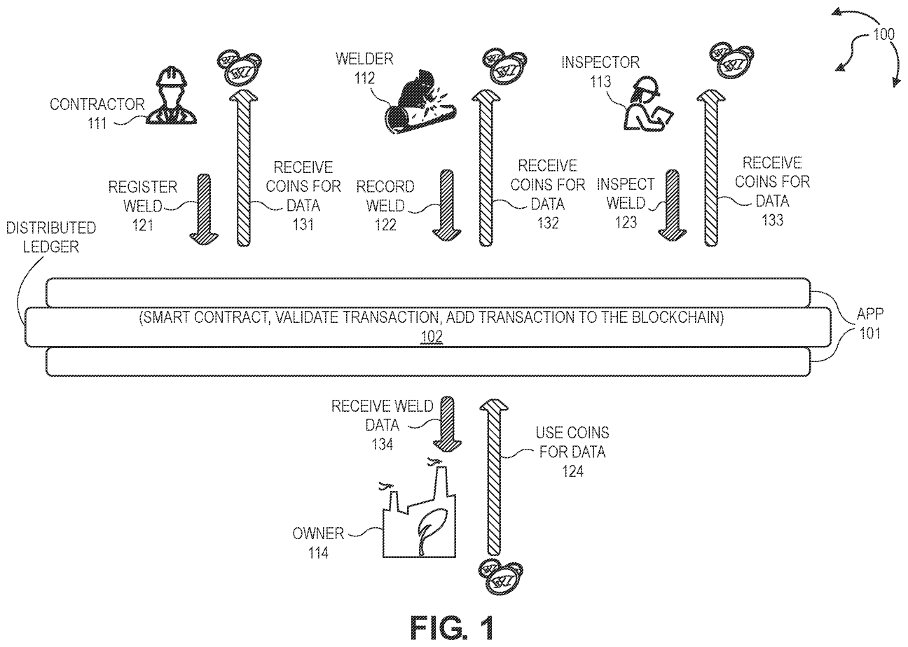

FIG. 1 depicts an example distributed ledger ecosystem architecture 100. As depicted, distributed ledger ecosystem architecture 100 includes application 101, distributed ledger 102, contractor 111, welder 112, inspector 113, and owner 114. In general, application 101 provides an interface for contractor 111, welder 112, inspector 113, and owner 114 (as well as other parties) to interact with distributed ledger 102. Application 101 can interoperate with distributed ledger 102 (e.g., an Ethereum blockchain or other blockchain) to facilitate various blockchain operations. For example, application 101 can interoperate with distributed ledger 102 to support smart contracts, validate transactions, add transactions, etc.

More specifically, different users can use application 101 to store weld (or other industrial process data) in distributed ledger 102. For example, contractor 111 (or some other industrial process worker) can use application 101 to submit weld registration data 121 (or other industrial process data) to distributed ledger 102 and receive coins 131 from distributed ledger 102 in return. Similarly, welder 112 (or some other industrial process worker) can use application 101 to submit weld recording data 122 (or other industrial process data) distributed ledger 102 and receive coins 132 from distributed ledger 102 in return. Likewise, inspector 113 (or some other industrial process worker) can use application 101 to submit weld inspection data 123 (or other industrial process data) to distributed ledger 102 and receive coins 133 distributed ledger 102 in return.

On the other hand, owner 114 (or some other industrial process owner) can use application 101 to submit coins 123 to distributed ledger 102 and receive weld data 134 (or other industrial process data) from distributed ledger 102 in return. Weld data 134 can include one or more data elements from at least one of: weld registration data 121, weld recording data 122, and weld inspection data 123. In other aspects, received other process data can include at least portions of other process data submitted to distributed ledger 102 by one or more process workers.

Accordingly, an industrial process (e.g., weld) ledger can be deployed on a distributed ledger (e.g., blockchain). The distributed ledger can be a permissionless blockchain platform using Proof of Work (PoW) consensus. In another aspect, the distributed ledger can be a blockchain that uses Proof of Stake (PoS) increasing efficiency and reducing energy consumption associated with transaction verification.

An industrial process (e.g., weld) application (e.g., application 101) can be deployed to computing systems and/or computing devices as a distributed application for both desktop and mobile access. As the application is distributed, the application is maintained by multiple nodes (as opposed to a central entity), facilitating low-cost, robust operation free of interruptions.

In one aspect, transaction within distributed ledger ecosystem architecture 100 can be managed using (e.g., Ethereum) smart contracts. The contracts can be open for anyone to review and audit and, once deployed, can be updated (e.g., only) by a consensus of ecosystem token holders. A smart contract can be a computer program or a transaction protocol intended to automatically execute, control or document legally relevant events and actions according to the terms of a contract or an agreement.

Token (e.g., coins 131, 132, 133, 134, etc.) can be an ERC-20 fungible token that is used to transact on distributed ledger ecosystem architecture 100. Users who add verified transactions to distributed ledger 102 can earn token and users who need to extract information from distributed ledger 102 can use token to enable the transaction. The token can also be used to pay for network and application fees associated with the network. The value of the token can be fixed, but the amount of token earned and required to extract information can be set by a distributed ledger ecosystem market based on reduced cost for the producers and consumers of welding (or other industrial process) information.

Underlying smart contracts and further development activity can be managed by a Distributed Autonomous Organization. Token holders are able to make recommendations regarding contract and application updates and have a vote proportional to the tokens they hold.

In one aspect, only transaction and verification information is stored on distributed ledger 102 in order to keep overall network cost low. In another aspect, other process-related information is stored along with transaction and verification information on distributed ledger 102. It may be that evidence documents are required to be retrievable as part of the welding (or other industrial process) specification. Evidence documents can be stored using other storage resources (i.e., “off-chain”), such as, for example, on an Interplanetary File Server (IPFS), a secure, peer-to-peer network for storing and sharing data in a distributed file system.

Distributed ledger ecosystem architecture 100 can use public/private key cryptography to enhance security and privacy. Distributed ledger ecosystem architecture 100 can use Internet of Things (IoT) Application Programming Interfaces (APIs) to connect with welding, biometric and inspection (or other industrial process) equipment for secure and efficient transfer of welding (or other industrial process) information to distributed ledger 102. Distributed ledger ecosystem architecture 100 can user Personal Identification technology, along with trusted certificate verification protocols to establish the credentials of users interacting with distributed ledger ecosystem architecture 102.

Accordingly, using a distributed application (e.g., application 101) welders (e.g., welder 112) (or other industrial process workers) are able to maintain a verified record of their weld (or other industrial process) performance history and current qualifications, across all industries, sites and contractors. Distributed ledger 102 serves as a verified work history that can be shared with employers to reduce re-testing requirements or with employment agencies to enhance job opportunities. Access to this information is protected and is only shared with new employers or agencies with the welder's (or other industrial process worker's) permission. Welders (or other industrial process workers) earn token when their verified welds (or other verified industrial process) are added to distributed ledger 102.

Utilizing a distributed application (e.g., application 101), inspectors (e.g., inspector 113) have access to real-time welding (or other industrial process) logs and inspection records and have access to their weld (or other industrial process) inspection history across inspection companies and owners. The inspector's weld (or other industrial process) inspection certifications are maintained within distributed ledger 102 for real time verification during the weld (or other industrial process) inspection process. Inspectors earn token when their verified inspections are added to distributed ledger ecosystem.

Contractors (e.g., contractor 111) are relieved from having to maintain custom databases or paper weld (or other industrial process) and inspection logs for their projects. The distributed application (e.g., application 101) can maintain a permanent and verified record of welds (or other industrial processes) and inspections for incorporation into commissioning packages. Weld (or other industrial process) information on distributed ledger 102 is available to BIM and Scheduling/Progressing software through standard distributed ledger (e.g., blockchain) APIs for real-time project updates. Distributed ledger technology can be deployed and maintained for a fraction of the cost of in-house or third-party proprietary systems. Contractors earn token when their verified project welds (or other industrial processes) are added to distributed ledger 102.

Owners and their engineers no longer need to develop and maintain custom weld (or other industrial process) documentation systems for their projects and facilities. Distributed ledger 102 can maintain a permanent, confidential and immutable record in a common, open format used by welders (or other industrial process workers), inspectors, engineers and suppliers. Data on distributed ledger 102 is verified with smart contracts in real time, reducing (and potentially eliminating) the need for time-consuming audits during the commissioning process. Owners are able to use verified contractor welding (or other industrial process) performance information as part of the pre-qualification process. Access to project and site welding (or other industrial process) data is obtained with token purchasable with crypto or fiat currencies.

Welding (or other industrial) equipment manufacturers can connect their machines to distributed ledger ecosystem architecture 100 to streamline weld (or other industrial process) information transfer and enhance the value of their offering. Material and consumable suppliers can now load their certified information once onto distributed ledger 102 for access during the welding (or other industrial) process such as MTRs, gas, filler and electrode certs as required by the welding (or other industrial) specification. Adding certified information to distributed ledger 102 significantly reduces repeated requests for the same information by multiple parties. Suppliers can earn token when they add verified information to distributed ledger 102.

Once information is verified and added to distributed ledger 102, the information lives permanently on the web and cannot be altered. Individuals or institutions with the proper credentials can access the information with open-source tools or customized web-based applications. Information for commissioning and validation is shared directly on distributed ledger 102 (e.g., a blockchain), not copied and sent between parties. The distributed ledger ecosystem architecture 100 is not owned or maintained by any one entity. It is public and available for the benefit of the entire community.

Any evidence document that is uploaded to distributed ledger 102 is stored on a networked file system. Similar to the distributed ledger 102, this networked file system is distributed over the web and is permanent and highly secure. The cost of storing evidence documents on the networked file system can be included in distributed ledger transaction costs.

Distributed ledger ecosystem architecture 100 can be implemented in a (e.g., Ethereum) blockchain platform having proven itself as a secure, robust and immutable.

In one aspect, distributed ledger ecosystem architecture 100 uses a consensus protocol (Proof of Work) to confirm additions to the distributed ledger 102. In another aspect, distributed ledger ecosystem architecture 100 uses a different consensus protocol (Proof of Stake) to confirm additions to the distributed ledger 102. Proof of Stake can use less computing power and processes transactions more efficiently relative to Proof of Work.

Welds (or other industrial processes) that have not been fully verified on distributed ledger 102 can be added in order to bring prior projects or a welder's (or other industrial process worker's) history up to date. However, these welds (or other industrial processes) can be tagged as “unverified” on the distributed ledger 102.

In general, distributed ledger (blockchain) technology can significantly reduce the cost of data collection, verification and storage vs paper-based systems.

Accordingly, distributed ledger ecosystem architecture 100 can provide an exclusive permanent record of certified welds (or other industrial processes) and their inspections. Distributed ledger ecosystem architecture 100 can be acceptable for ASME, AWS, API, NFPA, AHJs and cGMP weld documentation as well as standards for other industrial process documentation.

As such, distributed ledger (e.g., blockchain) technology can be used to track the welding process (or other industrial processes) through the entire supply chain to the end user. An open node deployment can be used as opposed to a closed, proprietary ledger, thereby reducing concerns over centralized control. Smart contracts can be incorporated as part of the distributed ledger technology in order to facilitate earning and redeeming the tokens enabling the ecosystem.

Aspects of the invention integrate Artificial Intelligence (AI), IoT, and construction technologies to facilitate labor friendly reduced cost secure and private transactions.

Token can be used to bootstrap development and adoption of the distributed ledger ecosystem. Token can be earned by sharing weld-related (or other industrial process) information. End-users of weld-related (or other industrial process) information can pay for the information using token. As such a two-sided market is created for the token as a means of producing and consuming weld-related (or other industrial process) information. Use of token can be limited to transactions associated with verifiable information stored within the distributed ledger ecosystem. Services, such as, welding, inspections, materials, etc. can be paid for using other payment mechanisms.

Welders, other industrial process workers, and inspectors can be assigned digital identities which can be verified at the time of entry using mobile phone based biometric sensors. Automatic welding machines can upload weld reports to the manufacturer which can then be available for inclusion in the distributed ledger. Other automated industrial machines can upload industrial process reports to manufactures which can then be available for inclusion in the distributed ledger. Local positioning devices can verify the weld (or other industrial process) location tied to a BIM model. IoT devices can be used for data collection and these can be leveraged for any last mile activities.

In one aspect, each weld is assigned a signature that can be identified through AO analysis of (e.g., circumferential) photograph of the weld. As such, welds can be identified without compromising the weld integrity or having to look up the identity based on a weld map stored on drawings or in a model. Other industrial process results can similar be assigned a signature used for subsequent identification using AO analysis. As such, other industrial process results can also be identified without compromising industrial process integrity or having to look up in other ways.

In another aspect, a web interface facilitates contractors, welders, other industrial process workers, and inspectors adding welding (or other industrial process) data to a distributed ledger ecosystem and owners extracting welding (or other industrial process) data from the distributed ledger ecosystem. Contributors of valid weld (or other industrial process) data can receive tokens, or credits for adding the welding data (or other industrial process) and owners can use tokens, or credits, for extracting the welding (or other industrial process) data.

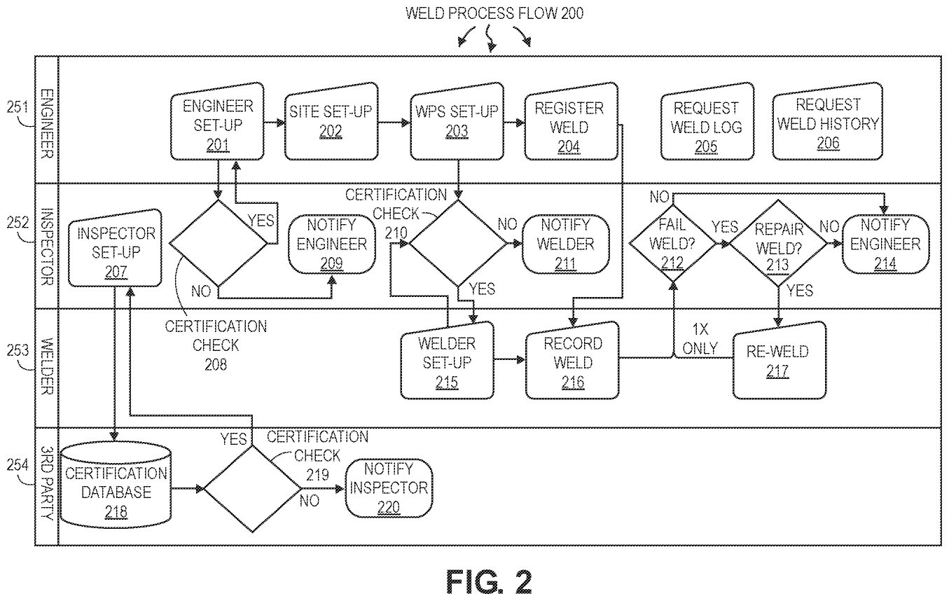

FIG. 2 depicts an example process flow 200 for utilizing weld information in a distributed ledger ecosystem. Process flow 200 can be implemented using the components and data described with respect to distributed ledger ecosystem architecture 100. Process flow 200 depicts the relationships and sequences for setting up, certifying, recording and extracting weld related documentation from a blockchain. Different acts of profess flow 200 can be performed by engineer 251, inspector 252, welder 253, and 3^{rd} party 254.

Engineer 251 can perform engineer set-up 201, site set-up 202, WPS set-up 203, and register weld 204 (e.g., on distributed ledger 102). Engineer 251 can also request weld log 205 and request weld history 206.

Welder 253 can perform welder set-up 215, record weld 216 (e.g., on distributed ledger 102), and, when appropriate, re-weld 217.

3^{rd} party 254 can maintain certification data 218. 3^{rd} party 254 can perform a certification check 219 of certification database 218. If the certification check fails, 3^{rd} party 254 can notify inspector 252 (act 220).

Inspector 252 can perform inspector set-up 207. Inspector set-up 207 can include checking certification database 218. Inspector 252 can also perform certification check 208 of engineer set-up 201. If certification of engineer set-up 201 fails (No at 208), inspector 252 can notify engineer 251 (act 209). Inspector 252 can also perform certification check 210 of welder set-up 215. If certification of welder set-up 215 fails (No at 210), inspector 252 can notify welder 251 (act 211).

Inspector 252 can inspect the weld. If the weld passes (No at 212), engineer 251 is notified (act 214). If the weld fails (Yes at 212), inspector 252 determines if the weld can be repaired 218. If the weld can be repaired (Yes at 218), welder 253 re-welds 217. If the weld cannot be repaired (Not at 218), inspector 252 notifies engineer 251 (act 214). Inspector 252 can submit various weld inspection data on distributed ledger 102.

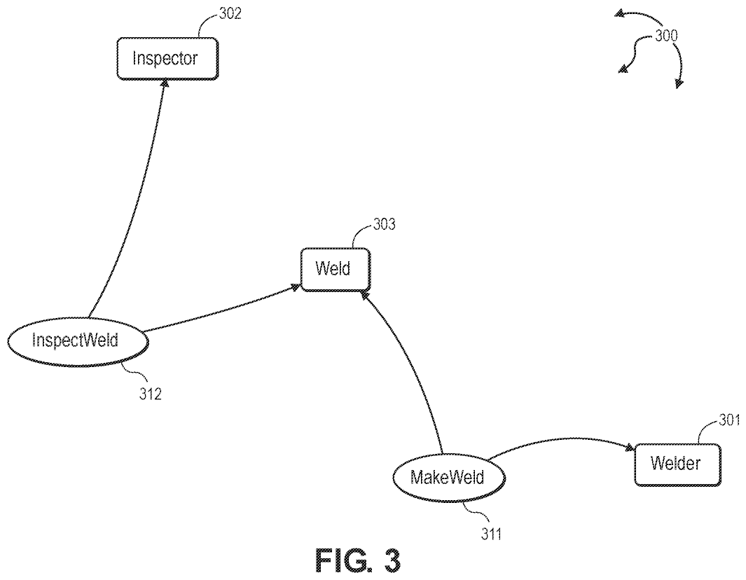

FIG. 3 depicts an example map 300 of asset and smart contract functions. Map 300 depicts welder 301, inspector 302, and weld 303 as blockchain assets. Making a weld (MakeWeld 311) and inspecting a weld (InspectWeld 312) are functions governed by a smart contract on the blockchain. Data contributing elements welder 301, inspector 302, and weld 303 can have certifications. The certifications can accessed, verified (authenticated) “off-chain”, and validated “on-chain” to insure that desired specifications, project guidelines, etc. have been met.

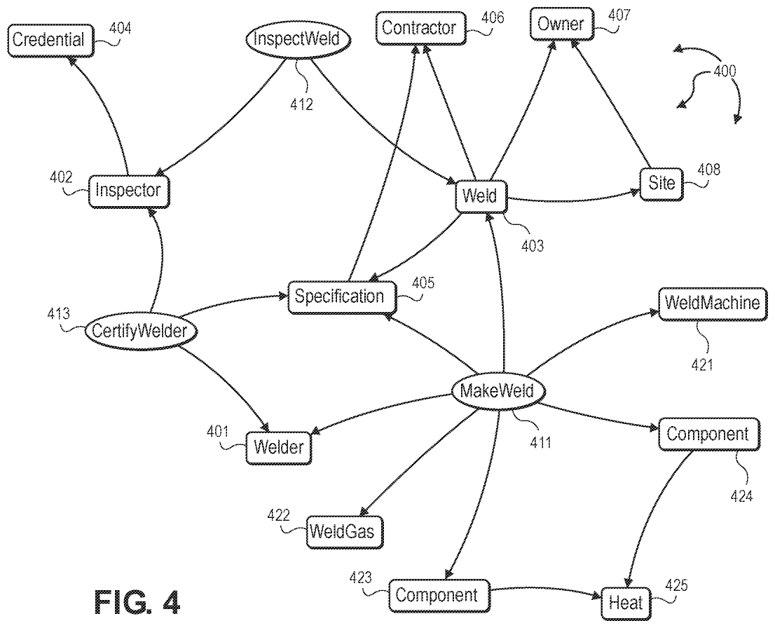

FIG. 4 depicts an example map 400 of asset and smart contract functions. Map 400 depicts welder 401, inspector 402, credential 404, specification 405, contractor 406, weld 403, owner 407, site 408, weldmachine 421, weldgas 422, component 423, component 422, and heat 425 as blockchain assets. Making a weld (MakeWeld 411), inspecting a weld (InspectWeld 412), and certifying a welder (CertifyWelder 413) are functions governed by a smart contract on the blockchain. Data contributing elements welder 401, inspector 402, credential 404, specification 405, contractor 406, weld 403, owner 406, site 408, weldmachine 421, weldgas 422, component 423, component 422, and heat 425 can have certifications. The certifications can be accessed, verified (authenticated) “off-chain”, and validated “on-chain” to insure that desired specifications, project guidelines, etc. have been met.

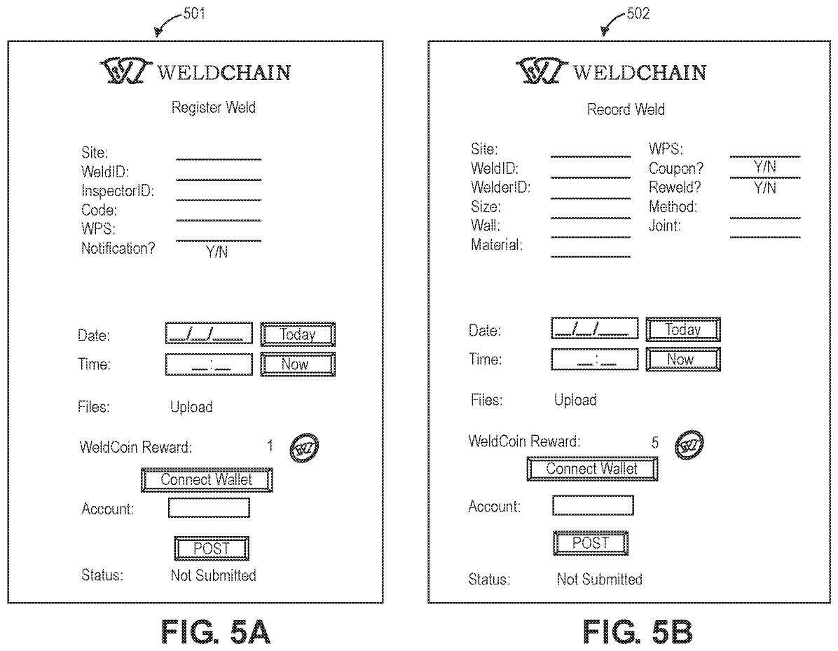

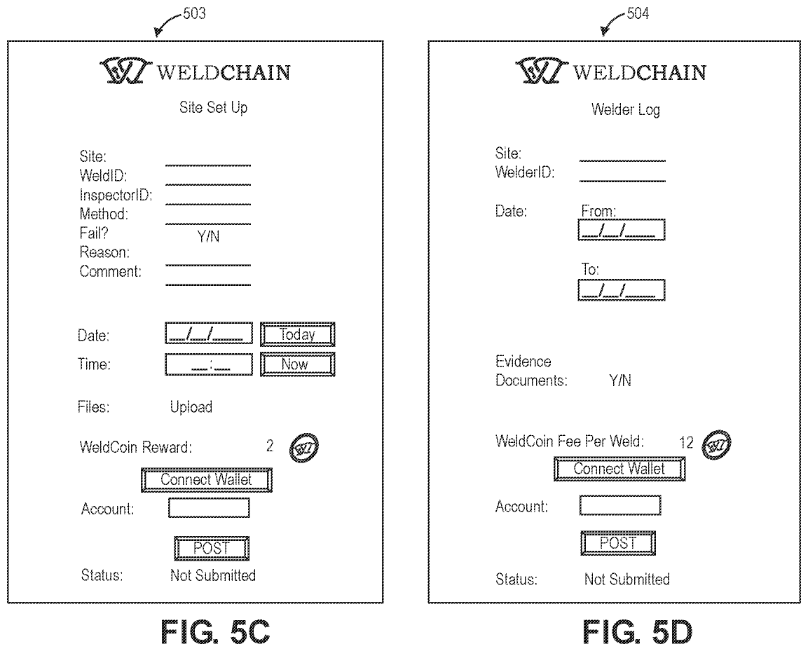

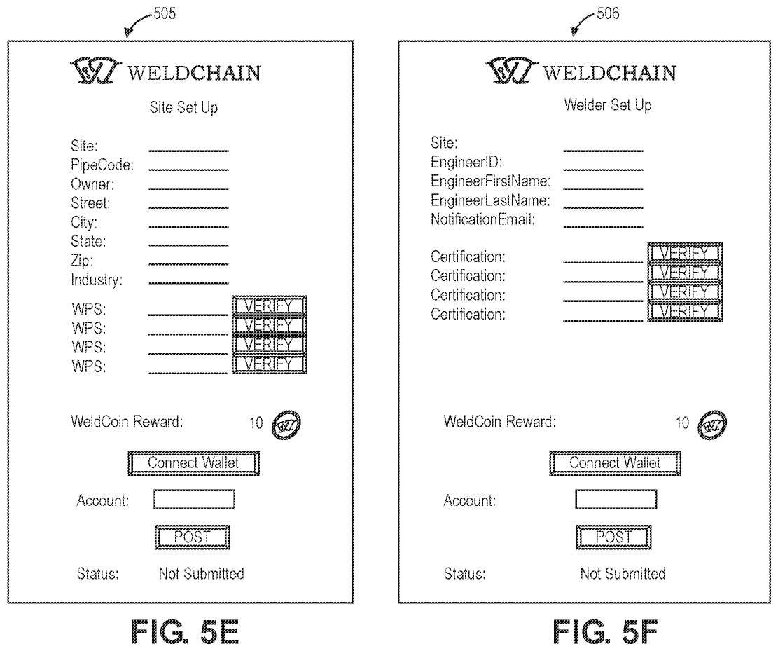

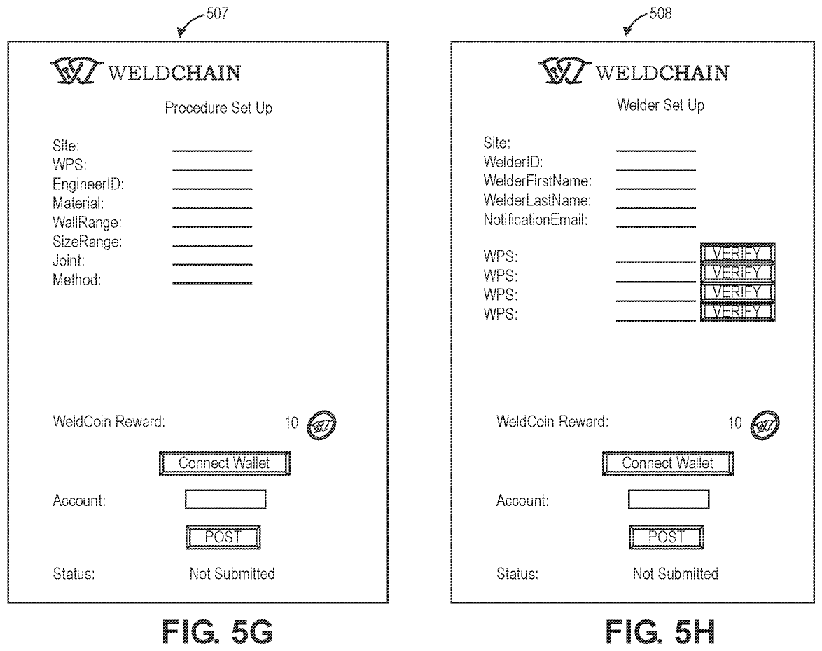

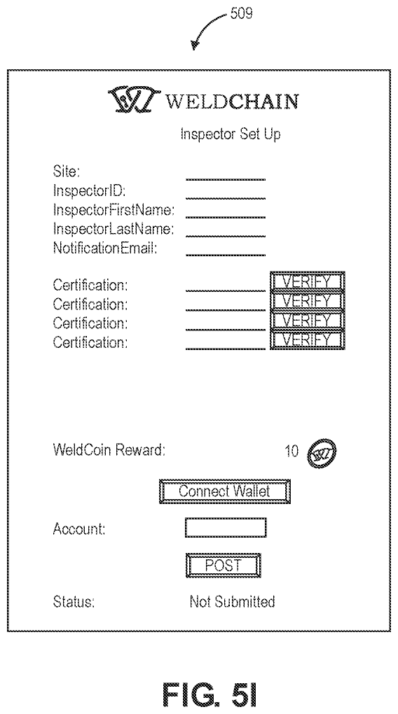

FIG. 5A depicts a user interface screen 501 for registering a weld. A person registering a weld can connect to their wallet. For example, the user can enter an account number in the appropriate field and select the ‘connect wallet’ user-interface control. Upon posting the indicated weld registration information, the person can receive a token reward into their wallet. In one aspect, interface screen 501 is a screen presented by application 101. A contractor or engineer enters weld registration information into the fields of interface screen 501. The contractor or engineer then selects the ‘POST’ user interface control. In response, application 101 puts the entered weld registration information into distributed ledger 102. In response to receiving the weld registration information, distributed ledger 102 returns the token reward to the contractor's or engineer's wallet.

FIG. 5B depicts a user interface screen 502 for recording a weld. A person recording a weld can connect to their wallet. For example, the user can enter an account number in the appropriate field and select the ‘connect wallet’ user-interface control. Upon posting the indicated weld recordation information, the person can receive a token reward into their wallet. In one aspect, interface screen 502 is a screen presented by application 101. A welder enters weld recordation information into the fields of interface screen 502. The welder then selects the ‘POST’ user interface control. In response, application 101 puts the entered weld recordation information into distributed ledger 102. In response to receiving the weld registration information, distributed ledger 102 returns the token reward to the welder's wallet.

FIG. 5C depicts a user interface screen 503 for a weld inspection. A person inspecting a weld can connect to their wallet. For example, the user can enter an account number in the appropriate field and select the ‘connect wallet’ user-interface control. Upon posting the indicated weld inspection information, the person can receive a token reward into their wallet. In one aspect, interface screen 503 is a screen presented by application 101. An inspector enters weld inspection information into the fields of interface screen 503. The inspector then selects the ‘POST’ user interface control. In response, application 101 puts the entered weld inspection information into distributed ledger 102. In response to receiving the weld inspect information, distributed ledger 102 returns the token reward to the inspector's wallet.

FIG. 5D depicts a user interface screen 504 for requesting a weld log for a welder. A person requesting a weld log can connect to their wallet. For example, the user can enter an account number in the appropriate field and select the ‘connect wallet’ user-interface control. Upon requesting the indicated weld inspection information, the person is charged an amount of token from their wallet. In one aspect, interface screen 504 is a screen presented by application 101. An owner enters weld log information into the fields of interface screen 504. The owner then selects the ‘GET’ user interface control. In response, application 101 submits the entered weld log to distributed ledger 102. In response to receiving the weld log information, distributed ledger 102 returns the relevant weld log data and deducts the token fee from the owner's wallet. The relevant weld log data can include one or more individual data elements from a weld log entry or may include the entire weld log entry. Purchases some but not all data elements of the weld log entry gives a customer more granular control over data purchases.

FIG. 5E depicts a user interface screen 505 for site set up. A person setting up a site can connect to their wallet. For example, the user can enter an account number in the appropriate field and select the ‘connect wallet’ user-interface control. Upon posting the indicated site information, the person can receive a token reward into their wallet. In one aspect, interface screen 505 is a screen presented by application 101. An engineer enters site setup information into the fields of interface screen 505. The engineer then selects the ‘POST’ user interface control. In response, application 101 puts the entered site setup information into distributed ledger 102. In response to receiving the site setup information, distributed ledger 102 returns the token reward to the engineer's wallet. Prior to submission, the engineer can select the relevant ‘VERIFY’ user interface control to verify information.

FIG. 5F depicts a user interface screen 506 for engineer set up. A person setting up as an engineer can connect to their wallet. For example, the user can enter an account number in the appropriate field and select the ‘connect wallet’ user-interface control. Upon posting the indicated engineer information, the person can receive a token reward into their wallet. In one aspect, interface screen 506 is a screen presented by application 101. An engineer enters engineer setup information into the fields of interface screen 506. The engineer then selects the ‘POST’ user interface control. In response, application 101 puts the entered engineer setup information into distributed ledger 102. In response to receiving the engineer setup information, distributed ledger 102 returns the token reward to the engineer's wallet. Prior to submission, the engineer can select the relevant ‘VERIFY’ user interface control to verify certifications.

FIG. 5G depicts a user interface screen 507 for a procedure set up. A person setting up a procedure can connect to their wallet. For example, the user can enter an account number in the appropriate field and select the ‘connect wallet’ user-interface control. Upon posting the indicated procedure information, the person can receive a token reward into their wallet. In one aspect, interface screen 507 is a screen presented by application 101. An industrial process worker enters procedure setup information into the fields of interface screen 507. The industrial process worker then selects the ‘POST’ user interface control. In response, application 101 puts the entered procedure setup information into distributed ledger 102. In response to receiving the procedure setup information, distributed ledger 102 returns the token reward to the industrial process worker's wallet.

FIG. 5H depicts a user interface screen 508 for a welder set up. A person setting up as a welder can connect to their wallet. For example, the user can enter an account number in the appropriate field and select the ‘connect wallet’ user-interface control. Upon posting the indicated welder information, the person can receive a token reward into their wallet. In one aspect, interface screen 508 is a screen presented by application 101. A welder enters welder set up information into the fields of interface screen 508. The industrial process worker then selects the ‘POST’ user interface control. In response, application 101 puts the entered welder set up information into distributed ledger 102. In response to receiving the welder setup information, distributed ledger 102 returns the token reward to the welder's wallet. Prior to submission, the welder can select the relevant ‘VERIFY’ user interface control to verify information.

FIG. 5I depicts a user interface screen 509 for an inspector set up. A person setting up as an inspector can connect to their wallet. For example, the user can enter an account number in the appropriate field and select the ‘connect wallet’ user-interface control. Upon posting the indicated inspector information, the person can receive a token reward into their wallet. In one aspect, interface screen 509 is a screen presented by application 101. An inspector enters inspector setup information into the fields of interface screen 503. The inspector worker then selects the ‘POST’ user interface control. In response, application 101 puts the entered inspector setup information into distributed ledger 102. In response to receiving the inspector setup information, distributed ledger 102 returns the token reward to the inspector's wallet. Prior to submission, the inspector can select the relevant ‘VERIFY’ user interface control to verify certifications.

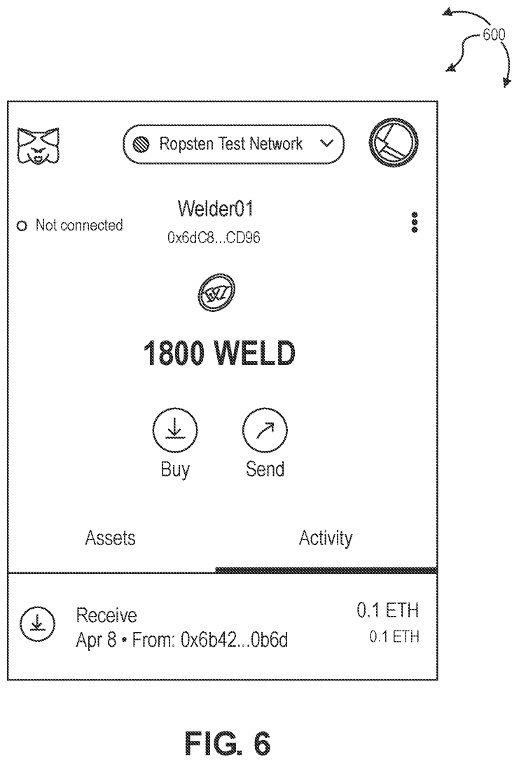

FIG. 6 depicts an example of a user wallet screen 600.

In one aspect, a welding machine is connected to a network facilitating communication between the welding machine and a distributed ledger. In one aspect, a welder programs the welding machine to make a weld. In another aspect, the welder configures the welding machine to access a welding program from a storage or network location. The program can define a weld the welding machine is to perform. The welder than activates the welding machine (e.g., hits a start button) or the welding machine activates in some automated manner The welding machine accesses and/or executes the program performing the weld in accordance with the program.

During the welding process, the welding machine collects weld information associated with the weld, including the welder's identity, properties of the welding program (e.g., amperage, electrode controls, etc.), any variables recorded during the welding operation, any fault codes, etc. In one aspect, the welding machine alternately and/or in combination collects data utilized to complete the fields in user interface screen 502. The welding machine then stores the weld information (e.g., via network communication) to the distributed ledger.

A welder can receive some amount of token when weld information corresponding to a weld is stored from the welding machine to the distributed ledger. Storing the weld information into the distributed ledger can facilitate and/or be part of a smart contract. A welder can be incentivized to store the weld information to the distributed ledger by being rewarded with an amount of token when the weld information is stored to the distributed ledger in a timely and accurate fashion. For example, it can be determined that the weld data was stored in the distributed ledger within a specified amount of time after the weld was created.

In further aspects, other types of machines implementing industrial processes are connected to a network facilitating communication between the machines and a distributed ledger. In one aspect, an industrial process worker (e.g., a front-line worker) programs an industrial process machine to perform an industrial process. In another aspect, the industrial process worker configures the industrial process machine to access an industrial process program from a storage or network location. The program can define an industrial process the industrial process machine is to perform. The industrial process worker then activates the industrial process machine (e.g., hits a start button) to perform the industrial process or the industrial process machine activates in some automated manner The machine accesses and/or executes the program performing the weld in accordance with the program.

During the industrial process, the industrial process machine collects and stores industrial process information including the industrial process worker's identity, properties of the industrial process program (e.g., electrical operating properties, processing specific operating properties, etc.), any variables associated with the industrial process, any errors, etc. In one aspect, the industrial process machine alternately and/or in combination collects data utilized to complete fields of a user interface screen relevant to the industrial process (e.g., similar to interface screen 502 but for a different industrial process).

An industrial process worker (e.g., a machine operator) can receive some amount of token when industrial process information corresponding to an industrial process is stored from the industrial process machine to the distributed ledger. Storing the process information into the distributed ledger can facilitate and/or be part of a smart contract. A industrial process worker (e.g., a machine operator) can be incentivized to store process information to the distributed ledger by being rewarded with an amount of token when the process information is stored to the distributed ledger in a timely and accurate fashion. For example, it can be determined that the process data was stored in the distributed ledged within a specified amount of time after the industrial process completed.

In this description and the following claims, an “industrial process” is defined as procedures including one or more of: chemical, physical, electrical, or mechanical actions to aid in the manufacture of one or more items. Industrial processes include: creating cement, creating steel, creating aluminum, creating fertilizer, disinfection, electrolysis, metalizing, plating, spin coating,

Gilding, electroplating, anodization, electrowinning, electopolishing, electrofocusing, electrolytic process, electrophoretic deposition, electrotyping, shearing, sawing, plasma cutting, water-jet cutting, Oxyacetylene cutting, Electrical discharge machining (EDM), Machining, Laser cutting, Smelting and direct Reduction, Forging, Casting, Steelmaking, Progressive stamping, Stamping, Hydroforming, Sandblasting, Soldering, brazing, welding, Tumble polishing, Precipitation hardening, Work hardening, Case hardening, differential hardening, shot peening, Die cutting, Electric arc furnace processing, Smelting, Catalan forge, open hearth furnace, bloomery, Siemens regenerative furnace, Blast furnace, Direct Reduction, Crucible steel, Cementation process, Bessemer process, Basic oxygen steelmaking, casting, sand casting, sintering, powder metallurgy, blow molding, compression molding, comminution, Froth flotation, flotation process, liquid-liquid extraction, frasch process, distillation, Fractional distillation, steam distillation, vacuum distillation, Batch distillation, Continuous distillation, Fractionating column, Spinning cone, additive manufacturing, Fused deposition modeling (1-DM), Stereolithography (SLA), Selective laser sintering (SLS), Photolithography, Cracking (chemistry), Alkylation, Burton process, Cumene process, Friedel-Crafts reaction, Kolbe-Schmitt reaction, Olefin metathesis, thermal depolymerization, Transesterification, Raschig process for production of hydroxylamine, Oxo process, Polymerisation Alberger process, Grainer evaporation process, Bacterial oxidation, Bayer process, Chloralkali process, Weldon process, Dow process, Girdler sulfide process, Hunter process, Kroll process, Industrial rendering, Lead chamber process, contact process, Mond process, Nitrophosphate process, Ostwald process, Packaging, Pidgeon process, Steam reforming, water gas shift reaction, Vacuum metalising, Van Arkel—de Boer process, and Formox process as well as any combinations thereof.

Various industrial machines can be configured to implement different portions of an industrial process or a chain of interoperating industrial processes. Industrial machines can include general purpose as well as special purpose computing components that execute instructions to control other components of an industrial machine or industrial machines facilitating performance an industrial process or a chain of interoperating industrial processes.

In this description and the following claims, “front-line worker” is defined as a worker that performs transactions (e.g., portions of work) related to welding, manufacturing, construction, transportation, etc. processes as well inspectors that inspects results of performed transactions. For example, during a manufacturing process, a front-line worker can mechanically couple (connect) two more components together. During a construction process, a front-line worker can torque bolts connecting structural members. Alternately, and as described, a front-line worker can weld structure members together. During a transportation process, a front-line worker can deliver materials to a factory or construction site.

At the time a front-line worker performs a transaction, it may be appropriate to collect accurately and timely transaction/process information about the transaction and the front-line worker's certifications. The front-line worker may be best suited to collect and record the transaction/process information.

A front-line work or associated machine can store the transaction/process information (e.g., via network communication) to a distributed ledger. A front-line worker can receive some amount of token when transaction/process information corresponding to process is stored to the distributed ledger. Storing the process information into the distributed ledger can facilitate and/or be part of a smart contract. A front-line worker can be incentivized to store transaction/process information to the distributed ledger by being rewarded with an amount of token when the transaction/process information is stored to the distributed ledger in a timely and accurate fashion.

In general, token can be exchange for fiat currency (e.g., U.S. dollars) or used on a platform to purchase services/information. For example, a front-line worker can use token to purchase a list of transactions or processes they are qualified to perform.

Implementations of the invention can comprise or utilize a special purpose or general-purpose computer including computer hardware, such as, for example, one or more computer and/or hardware processors (including any of Central Processing Units (CPUs), and/or Graphical Processing Units (GPUs), general-purpose GPUs (GPGPUs), Field Programmable Gate Arrays (FPGAs), application specific integrated circuits (ASICs), Tensor Processing Units (TPUs)) and system memory, as discussed in greater detail below. Implementations also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations can comprise at least two distinctly different kinds of computer-readable media: computer storage media (devices) and transmission media.

Computer storage media (devices) includes RAM, ROM, EEPROM, CD-ROM, Solid State Drives (“SSDs”) (e.g., RAM-based or Flash-based), Shingled Magnetic Recording (“SMR”) devices, Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

In one aspect, one or more processors are configured to execute instructions (e.g., computer-readable instructions, computer-executable instructions, etc.) to perform any of a plurality of described operations. The one or more processors can access information from system memory and/or store information in system memory. The one or more processors can (e.g., automatically) transform information between different formats.

System memory can be coupled to the one or more processors and can store instructions (e.g., computer-readable instructions, computer-executable instructions, etc.) executed by the one or more processors. The system memory can also be configured to store any of a plurality of other types of data generated and/or transformed by the described components.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, in response to execution at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the described aspects may be practiced in network computing environments with many types of computer system configurations, including, personal computers, desktop computers, laptop computers, message processors, hand-held devices, wearable devices, multicore processor systems, multi-processor systems, microprocessor-based or programmable consumer electronics, network PCs, minicomputers, mainframe computers, mobile telephones, PDAs, tablets, routers, switches, welding machines, other industrial machines, and the like. The described aspects may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more Field Programmable Gate Arrays (FPGAs) and/or one or more application specific integrated circuits (ASICs) and/or one or more Tensor Processing Units (TPUs) can be programmed to carry out one or more of the systems and procedures described herein. Hardware, software, firmware, digital components, or analog components can be specifically tailor-designed for a higher speed detection or artificial intelligence that can enable signal processing. In another example, computer code is configured for execution in one or more processors, and may include hardware logic/electrical circuitry controlled by the computer code. These example devices are provided herein purposes of illustration, and are not intended to be limiting. Embodiments of the present disclosure may be implemented in further types of devices.

The described aspects can also be implemented in cloud computing environments. In this description and the following claims, “cloud computing” is defined as a model for enabling on-demand network access to a shared pool of configurable computing resources. For example, cloud computing can be employed in the marketplace to offer ubiquitous and convenient on-demand access to the shared pool of configurable computing resources (e.g., compute resources, networking resources, and storage resources). The shared pool of configurable computing resources can be provisioned via virtualization and released with low effort or service provider interaction, and then scaled accordingly.

A cloud computing model can be composed of various characteristics such as, for example, on-demand self-service, broad network access, resource pooling, rapid elasticity, measured service, and so forth. A cloud computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the following claims, a “cloud computing environment” is an environment in which cloud computing is employed. In one aspect, a distributed ledger (e.g., a blockchain) is implemented “in the cloud”.

Components can be connected to (or be part of) a network, such as, for example, a system bus, a Local Area Network (“LAN”), a Wide Area Network (“WAN”), and even the Internet. Accordingly, these components, any other connected computer systems and their components can create and exchange data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (SOAP), etc. or using other non-datagram protocols) over the network.

The invention can be implemented on a blockchain. A blockchain is a decentralized, distributed, and oftentimes public, digital ledger consisting of records called blocks that is used to record transactions across many computers so that any involved block cannot be altered retroactively, without the alteration of all subsequent blocks. This allows the participants to verify and audit transactions independently and relatively inexpensively. A blockchain database can be managed autonomously using a peer-to-peer network and a distributed timestamping server.

Blockchains are authenticated by mass collaboration power by collective self-interests. Such a design facilitates robust workflow where participants' uncertainty regarding data security is marginal. The use of a blockchain removes the characteristic of infinite reproducibility from a digital asset. It confirms that each unit of value was transferred only once, solving the long-standing problem of double spending. A blockchain can be viewed as a value-exchange protocol. A blockchain can maintain title rights because, when properly set up to detail the exchange agreement, it provides a record that compels offer and acceptance.

A block chain can include multiple layers:
infrastructure (hardware)
networking (node discovery, information propagation and verification)
consensus (proof of work, proof of stake)
data (blocks, transactions)
application (smart contracts/Apps, if applicable)

Blocks hold batches of valid transactions that are hashed and encoded into a Merkle tree. Each block includes the cryptographic hash of the prior block in the blockchain, linking the two. The linked blocks form a chain. This iterative process confirms the integrity of the previous block, all the way back to the initial block, which is known as the genesis block.

Sometimes separate blocks can be produced concurrently, creating a temporary fork. In addition to a secure hash-based history, any blockchain has a specified algorithm for scoring different versions of the history so that one with a higher score can be selected over others. Blocks not selected for inclusion in the chain are called orphan blocks. Peers supporting the database have different versions of the history from time to time. They keep only the highest-scoring version of the database known to them. Whenever a peer receives a higher-scoring version (usually the old version with a single new block added) they extend or overwrite their own database and retransmit the improvement to their peers.

There is never an absolute guarantee that any particular entry remains in the best version of the history forever. Blockchains are typically built to add the score of new blocks onto old blocks and are given incentives to extend with new blocks rather than overwrite old blocks. Therefore, the probability of an entry becoming superseded decreases exponentially as more blocks are built on top of it, eventually becoming very low. For example, bitcoin uses a proof-of-work system, where the chain with the most cumulative proof-of-work is considered the valid one by the network. There are a number of methods that can be used to demonstrate a sufficient level of computation. Within a blockchain the computation is carried out redundantly rather than in the traditional segregated and parallel manner

The present described aspects may be implemented in other specific forms without departing from its spirit or essential characteristics. The described aspects are to be considered in all respects only as illustrative and not restrictive. The scope is, therefore, indicated by the appended claims rather than by the foregoing description. All changes which come within the meaning and range of equivalency of the claims are to be embraced within their scope.

What is claimed:

1. A method comprising:
accessing a program defining an industrial process to be performed at an industrial machine;
activating the industrial machine performing the industrial process in accordance with the program;
collecting industrial process data during and corresponding to performance of the industrial process; and
storing the industrial process data to a distributed ledger as a component of a smart contract associated with performing the industrial process.

2. The method of claim 1, wherein accessing a program defining an industrial process to be performed at an industrial machine comprises accessing a program defining a weld to be performed at a welding machine;
wherein activating the industrial machine performing the industrial process comprises activating the welding machine performing the weld;
wherein collecting industrial process data during and corresponding to performance of the industrial process comprises collecting weld data during and corresponding to performance of the weld; and
wherein storing the industrial process data to a distributed ledger as a component of a smart contract associated with performing the industrial process comprises storing the weld data to a distributed ledger as a component of a smart contract associated with performing the weld.

3. The method of claim 2, further comprising:
determining that the weld data was stored to the distributed ledger in a timely and accurate fashion; and
adding an amount of token to an account of a welder in response to determining that the weld data was stored to the distributed ledger in a timely and accurate fashion.

4. The method of claim 3, wherein collecting weld data comprises collecting one or more of: amperage, electrode controls, a weld identifier, a welder identifier, a weld size, or weld material.

5. The method of claim 1, further comprising:
determining that the industrial data was stored to the distributed ledger in a timely and accurate fashion; and
adding an amount of token to an account of a machine operator in response to determining that the process data was stored to the distributed ledger in a timely and accurate fashion.

6. The method of claim 1, wherein collecting industrial process data comprises collecting one or more of: an identity of an industrial machine operator, properties of the program, or one or more variables associated with the industrial process.

7. An industrial process machine comprising:
a processor;
system memory coupled to the processor and storing instructions configured to cause the processor to:
access a program defining an industrial process to be performed at an industrial machine;
activate the industrial machine performing the industrial process in accordance with the program;
collect industrial process data during and corresponding to performance of the industrial process; and
store the industrial process data to a distributed ledger as a component of a smart contract associated with performing the industrial process.

8. The industrial process machine of claim 7, further comprising instructions configured to:
determine that the industrial data was stored to the distributed ledger in a timely and accurate fashion; and
add an amount of token to an account of a machine operator in response to determining that the process data was stored to the distributed ledger in a timely and accurate fashion.

9. The industrial process machine of claim 7, wherein instructions configured to collect industrial process data comprise instructions configured to collect one or more of: an identity of an industrial machine operator, properties of the program, or one or more variables associated with the industrial process.

10. A welding machine comprising:
a processor;
system memory coupled to the processor and storing instructions configured to cause the processor to:
access a program defining a weld to be performed at a welding machine;
activate the welding machine performing the weld in accordance with the program;
collect weld data during and corresponding to performance of the weld; and
store the weld data to a distributed ledger as a component of a smart contract associated with performing the weld.

11. The welding machine of claim 10, further comprising instructions configured to:
determine that the weld data was stored to the distributed ledger in a timely and accurate fashion; and
add an amount of token to an account of a welder in response to determining that the weld data was stored to the distributed ledger in a timely and accurate fashion.

12. The welding machine of claim 10, wherein instructions configured to collect weld data comprise instructions configured to collect one or more of: amperage, electrode controls, a weld identifier, a welder identifier, a weld size, or weld material.
